(19) United States
(12) Patent Application Publication
(10) Pub. No.: US 2025/0097339 A1
(43) Pub. Date: Mar. 20, 2025

(54) System for coordinating a presentation on a group of mobile computing devices

(71) Applicant: Forty First Floor Pty Ltd, Maroochydore (AU)

(72) Inventor: Earle Rowan, Maroochydore (AU)

(21) Appl. No.: 18/721,863

(22) PCT Filed: Jun. 2, 2023
(86) PCT No.: PCT/AU2023/050480

§ 371 Date: Jun. 20, 2024

(30) Foreign Application Priority Data
Jun. 2, 2022 (AU) 2022901516

(51) Int. Cl. H04M 1/72427; G06T 7/73

(52) U.S. Cl. CPC H04M 1/72427; G06T 7/73; G06T 2207/10032

(57) ABSTRACT

A system for coordinating a presentation on a group of mobile computing devices in a area. The system comprises a plurality of mobile computing devices for running a software application which is adapted to connect to the server and display data on the mobile computing devices, a drone-mounted camera for monitoring the lighting output of the mobile computing devices in the given area and a processor for transmitting data to each mobile computing device in the group to activate the lighting output of each mobile computing device. The processor receives data from a camera about the positions of each mobile computing device within the given area, the server sends data to mobile computing devices in the correct position within the given area and the data controls the lighting output of each mobile computing device so as to form a presentation across all of the mobile computing devices in the given area.

### TECHNICAL FIELD

The present invention relates to the telecommunications industry and, more particularly to a computer implemented system for coordinating a presentation on a group of mobile computing devices.

### BACKGROUND

Synchronising the images displayed on a group of cell phones requires communications with every phone in a given area. A software application on each cell phone in a given area can be used to send data from the cell phones to a central sever (using LTE or Wi-Fi or other communications channels). However, it is difficult to identify the position of each phone within the given area in order to form the visual pattern displayed by the group of cell phones.

To identify the position of a phone within a given area, prior art patents have described using a cell phone's GPS data, Bluetooth™ beacons in various configurations, RTT signals on Wi-Fi or inserting data in a musical presentation. However, these prior art methods suffer from two issues: (1) positional accuracy, (2) crowd movement and (3) crowd uptake.

At this time, GPS cannot deliver better than 30-meter accuracy on most cell phones. In addition, GPS does not work accurately within indoor venues. Bluetooth™ can also be used to calculate the position of a cell phone in a given area. However, it only has an accuracy up of around 10 meters of an exact location, or around 3 meters using triangulation. Nevertheless, this accuracy range is insufficient to form an image.

Furthermore, all radio methodologies suffer from signal degradation. This can be due to the types of cell phones, the number of transmitting devices and the number devices within the given area. These issues are further exacerbated by any physical barriers such as metal seats and venue constructions. Even human bodies can act as a barrier for radio frequency signals.

The other constraining factor is crowd movement. For example, the audience is not static in a large outdoor gathering such as a rock concert. The audience moves around. Therefore, if a visual graphic pattern is to be displayed on the group of cell phones, then the data being used by each phone must be dynamically updated to reflect the cell phone's position within the graphic.

Another problem with systems for making groups of cell phones display certain data is privacy. Most people would not want an app to track their movements using GPS on a continued basis. Privacy is a concern that is not adequately addressed in the prior art.

The prior art specification of WO2019034556A1 discloses an invention which is not useful because it does not work in practice. The system of WO2019034556A1 requires a user to download an app and then denote their row and seat number in a stadium. For example, WO2019034556A1 states on page 6 lines 6 to 10 that: “In an initial step, a user device 200 provides location data to the server 100 identifying the location of the user device 200, in a given viewing zone. In this particular embodiment, the protocol applied is based on the following types of information provided by the user: seat number, row number, and in some cases Manager ID. The seat number and row number 10 provides location information, if the user is in a stadium type environment, for example.” The inventors were aware of this system at the time that they reduced their invention to practice, but the inventors found that the prior art invention of WO2019034556A1 did not work. The main reason is does not work is because people in stadiums do not always sit in their seat. They will often stand up during a presentation due to their excitement in which case their phone is held up in the air and thereby takes up the position of the row above them. In that instance, the system of D1 gets confused and does not display the presentation correctly across the crowd. The system of WO2019034556A1 does not work on a crowd where people are randomly distributed. The system of WO2019034556A1 relies on people staying in exactly defined positions, which are people are not likely to do voluntarily (particularly in venues such as concerts, where people move around at random due to their excitement).

Another prior art patent application is US2014193037A1 which describes invention wherein the phones of an audience are treated like pixels on a screen. However, the problem with this prior art invention is that a group of phones cannot represent a graphic like on a screen. In an audience, each adult individual takes up approximately 600 mm space in width. This means that on an average, each phone is surrounded by at least an area equivalent to 16 phones of vacant space. Moreover, each phone could be anywhere in that vacant space during a presentation. This situation is not the same as a traditional screen, where each pixel is adjacent and built specifically to display a graphic.

Another issue for the effective operation of a system according to the present invention is positioning the angle at which the camera views the audience. The camera needs to see as much of the audience as possible. It needs to be able image the crowd and all the light sources in it.

In stadium seating the audience may be position at an angle as steep as thirty-five degrees. When the crowd is on the ground, then the camera should be positioned above the crowd.

The camera needs to be positioned at an angle of at least forty-five degrees relative to the plane of the audience. Preferably, the camera is positioned at ninety degrees (perpendicular) to the plane of the audience. However, the system will still function if the camera is at least twenty-five degrees relative to the plane of the audience.

In a stadium scenario, the camera can be positioned on the opposite side of the stadium to the audience.

As shown in FIG. 1, the camera can be mounted to a drone 26 which can hover at a location which is perpendicular to the plane of the audience. Using a camera mounted on drone provides a substantial contribution to the working of the invention.

The invention of US2014193037A1 sends an image to a group of phones which displays a presentation across a crowd. A camera then photographs this presentation and returns the data to a computer which recognises which parts of the image are incorrect and resends the images to the phones.

However, like the invention of WO2019034556A1, the invention of US2014193037A1 relies on a fixed reference point to achieve accuracy in a presentation. As stated in paragraph 13 of US2014193037A1 “additional location information from connected display device(s) may comprise seat location information (e.g., for use in a stadium or arena environment), latitude-longitude information, other location information, a combination thereof, and/or the like.” In paragraph 15 of US2014193037A1 it states: each of the one or more connected display devices may continually or periodically transmit latitude and longitude information to a processing system.”

The system of US2014193037A1 relies on using standard image processing algorithms to correct an image displayed across a crowd of mobile phones. However, those algorithms only work if the image is only partially distorted and the pixels are regularly arranged, not if the entire image is distorted and all pixels are randomly distributed.

Another problem with the invention of US2014193037A1 is that the bandwidth required to send even 25 frames per second at a resolution of 1024×560 pixels to 5000 phones at a concert is not practical on a standard communications system, such as 4G or 5G over phones. It makes the system overly complex and liable to fail at a critical time in the performance.

Any attempt to use a group of phones as a graphic display would require a constant stream of data so regardless of the communications technology it will lock out the consumers phone for the full period of use.

If a presentation according to the invention of US2014193037A1 was done using a telecommunications provider running a 4G or 5G network channel, the app running the invention of US2014193037A1 would very quickly get disconnected. Video streaming using enormous bandwidth. Applying such a stream across 5,000 phones would totally consume normal phone usage. Normal communication channels are designed and instantiated for telecommunication operation, not video streaming.

A system is needed which can operate on any communications platform, even over the internet, without any effect on the communications platform and allow it to maintain its normal operation. This problem has not been solved effectively in the prior art.

The object of the present invention is to overcome or at least substantially ameliorate the aforementioned problems.

### SUMMARY OF THE INVENTION

According to the present invention, there is provided a computer implemented system for coordinating a presentation on a group of mobile computing devices in a given area, the system comprising:
(a) a server for hosting a software application;
(b) a plurality of mobile computing devices for running the software application which is adapted to connect to the server and display data on the mobile computing devices;
(c) a camera for monitoring the lighting output of the mobile computing devices in the given area; and
(d) a processor for controlling the camera and transmitting data to the software application running on each mobile computing device in the group to activate the lighting output of each mobile computing device,
   wherein:
   i. the processor receives data from the camera about the positions of each mobile computing device within the given area;
   ii. the server sends data to any mobile computing devices in the correct position within the given area; and
   iii. the data controls the lighting output of each mobile computing device rather than displaying footage on each mobile computing device, so as to form a presentation across all of the mobile computing devices in the given area.

Mobile computing devices could include phones or tablets, for example. However, for the sake of convenience, mobile computing devices will be referred to as ‘phones’ throughout the following portions of the specification.

The inventive step over the prior art was to realize that fixed positions of each phone was not required to make the presentation. The key to making the invention was to realize that any phone transmitting in the position corresponding to the image is the right phone to transmit data to. The prior art relied on phones staying in fixed positions (corresponding to row and seat numbers), which is not practical.

The other inventive step over the prior art was realizing that footage should not be transmitted to each phone, but only data to control the screen colour or the phone light. Transmitting footage requires too much bandwidth, too much data transmission and consumes all of the capacity of the phone. The stream of footage data in the prior art stops the phone from being able to work normally, such as to receive calls and messages.

The unknown position of any mobile computing devices in a presentation is preferably determined by:
(a) activating the light on a first mobile computing device in the group;
(b) obtaining visual feedback from the camera as to the position of that first mobile computing device in the group;
(c) recorrecting the position of that first mobile computing device in the group;
(d) activating the light on the next mobile computing device in the group;
(e) obtaining visual feedback from the camera as to the position of the next mobile computing device in the group;
(f) recorrecting the position of that next mobile computing device in the group;
(g) repeating the process for each mobile computing device in the group until all of the positions of all of the mobile computing devices in the group have been recorrected.

The system preferably includes on or more drones with the cameras mounted thereto in order to position the drones at optimal positions to view the mobile computing devices in the given area.

The system may uses a global position satellite system to differentiate groups in the given area and provides presentations to each different group in the given area. The present invention uses GPS as in the prior art, but in a way the inventors of the prior art did not conceive. This is because GPS is not suitable for providing sufficient accuracy to define the position of an individual phone for the system to work, but GPS can be used with sufficient accuracy to differentiate different groups within a given area (such as sections of a stadium).

The given area may be defined by marker lights detectable by the camera.

Any of the features described herein can be combined in any combination with any one or more of the other features described herein within the scope of the invention.

### BRIEF DESCRIPTION OF DRAWINGS

Embodiments of the invention will be described with reference to the following drawings, in which:

FIG. 1 is an illustration of the components in the system of the invention for facilitating a coordinated presentation on a group of phones.

FIG. 2 shows a data packet sent by the system to a phone used in the system of the present invention.

FIG. 3 is a representation of a sequence of pixels used to display a presentation on a group of phones used in the system of the present invention.

FIG. 4 shows a data table which denotes a specific sequence of two effects that are sent to a phone operating in the system of the present invention.

FIG. 5 shows the system of the present invention being used over a stadium.

### DETAILED DESCRIPTION

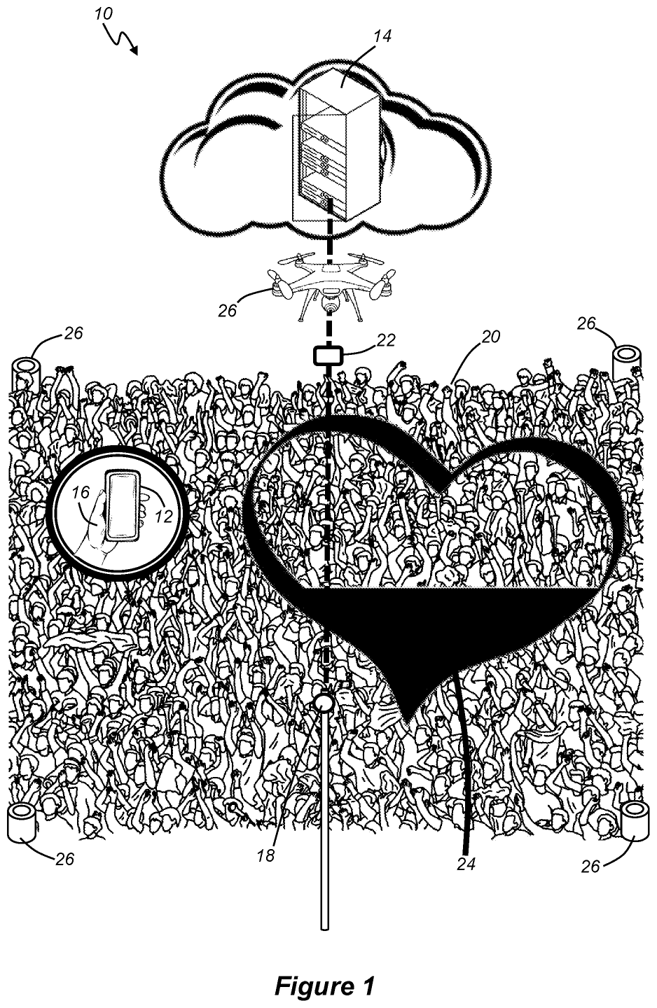

FIG. 1 shows a computer implemented system 10 for facilitating a coordinated presentation on a group of mobile computing devices (cell phones) 12.

The system 10 has a server 14 hosting a software application. The cell phones 12 run the software application which is adapted to connect to the server 14 and display visual information on the screens of the cell phones 12. Users 16 must download the software application on their cell phones 12 for the system 10 to work.

The system 10 includes a camera 18 for photographing a given area 20 in which users 16 of the cell phones 12 running the software application are displaying the screens of their cell phones 12.

A processor 22 is used to control the camera 18 and transmit data back to the server 14 to control the software applications running on the cell phones 12.

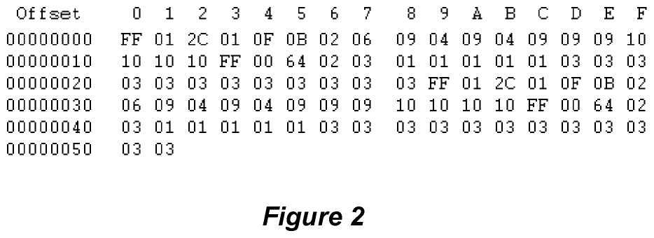

The camera 18 monitors the display of the screens of the cell phones 12 in the given area 20. As represented in FIG. 2, the server 14 effectively designates each screen of the cell phones 12 as a pixel in a coordinated image. Furthermore, the presentation is a sequence of coordinate images.

The server 14 receives feedback from the camera 18 via the processor 22. The server 14 then sends the appropriate colour and brightness data in an image file to each mobile computing device 12 to display the correct image in the sequence of the presentation on each cell phone 12 in the given area.

In the illustration of FIG. 1, the system 10 is presenting a heart presentation 24 on the group of cell phones 12 within the given area 20.

Each cell phone 12 is initially sent a randomly selected pixel file to calibrate the system. This causes each cell phone 12 to light up. The cell phones which are held up to the camera are deemed to be active pixels for use in the presentation.

In the system 10, there is no direct requirement for a cell phone 12 to identify itself to the server 14. The identification process is defined outside of the cell phone 12 using the camera 18.

The visual data transmitted by the server 14 to the cell phones 12 should consist of colours with high dynamic visibility.

As each cell phone 12 moves, the camera 18 relays new images to the processor 22 which transmits new data to the relevant cell phone 12 via the server 14 to continue displaying the presentation.

The files size of data transmitted to the cell phones 12 need to be very small to reduce the load on the network and increase the update speed of the presentation.

Each software application (‘app’) used in the present invention has a User Identifier (UID) number. When a phone 12 joins a specific presentation at a venue that UID is stored as an active participant in the system. The app is built to perform lighting effects when triggered to do so by a command issued by the server 14.

The phone 12 forms a constant static WebSocket connection with the server 14. WebSocket connections allow connections between a phone and a server. Over 1 million connections are possible with a WebSocket connection. The WebSocket connection does not consume any bandwidth except when the server 14 sends the phone 12 a command to perform a lighting action.

To determine the physical position of the phone 12 each phone is sent in sequence a command to turn on its light (whether it be the screen of the phone 12 or the torch on the phone 12). The server 14 tells the camera 18 focused on the audience to photograph the presentation.

The server 14 has a predetermined map of how the presentation 24 should look.

For example, if there were five phones used in the system and the data we expected to be on a first phone went to a fifth phone we then know from the camera feedback that the position of the first phone within the presentation has moved to the position of the fifth phone. The data dispatched to the fifth phone is corrected by the server 14 and the sequence continues until all of the phone positions within the presentation are known. If the phone moves position, then this does not perturb the system. Whatever phone is in the fifth position becomes the correct phone for displaying data at that position. This makes a substantial contribution to the working of the invention over the prior art which requires static mobile phones.

Because the inventors wanted the phones to continue with their prime functions as a phone even when in use as a light display element and the inventors needed to keep the communications bandwidth to an absolute minimum. The data sent to each phone also needs to be as compressed as much as possible.

If a presentation is required to be synchronised with music, then each phone is mapped on a software application tool and its performance within the presentation is determined. The performance will include what colour the phone should display, the time at which the phone screen should light up, when the light should be faded up, when the light should be faded down, the amount of lerp (linear interpolation or ‘drift’) between the colours displayed on the phone and other functions. Each phone app knows how to perform these functions on command.

An instruction for that light element is derived from the total display of all light elements in the presentation and that data is sent to each specific phone. The data sent to each phone is a sequence of timed commands which tell that phone screen when to turn on the time to stay on.

Controlling the lighting function of the phone rather than displaying footage is an important part of the compression of the data to each phone. If specific light element has to turn on and stay on for the duration of the presentation for 1 minute, it receives an instruction to do so which is approximately 3 bytes in size. This provides a significant improvement over the prior art, which relies on the streaming of video footage at twenty-five frames per second times 60 bytes of the data. (1500 bytes)

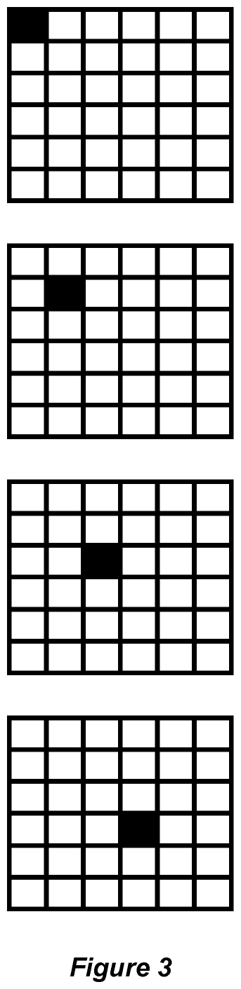

FIG. 3 shows a sample data table that is sent to each phone. The size of a data file sent to a specific phone 12 is determined by the number of graphic frames that are required to compose that presentation plus the frame rate that the frames should be displayed, and the number of times that graphic should be repeated. So, if the same graphic is to be maintained for sixty seconds, the frame rate is set to say one second and the repeat counter set sixty times. This is a significant reduction in data compared to a fixed frame rate such as twenty frames per second wherein the complete sequence would need to be repeated as twenty frames, times sixty seconds.

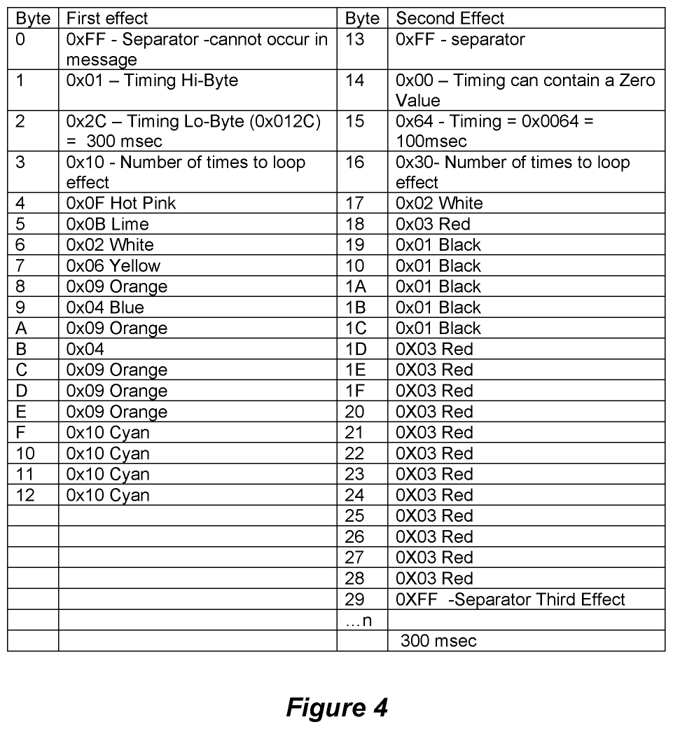

FIG. 4 shows a data table which denotes a specific sequence of two effects that are sent to a phone. This first effect is fifteen colours at three hundred milliseconds turning on and off in a loop ten times lasting for a total duration of forty-five seconds. The second effect is a sequence of nineteen colours turned for a flash (turning on and off) lasting one hundred milliseconds each and looped thirty times lasting for a total duration fifty-seven seconds. Each light element for a phone has a data table constructed like this for its part in the overall presentation.

Another program by the inventors is used to generate a series of frames which, when displayed, show the entire visual presentation. The data for each phone's participation in that visual presentation is extracted from the series of frames and compressed into binary files. For example, as per:
file 1=element (1, 1), (1, 2), (1, n . . . ),
file 2=element (2,1), (2,2), (2, n . . . ).

This process continues until all frames have been separated into binary files.

The numbered files are then available to be sent to each participating phone once each phone's correct position has been discovered using the process described in this invention. That is:
File 1 (1 to n . . . ) to the phone in derived position 1;
File 2 (1 to n . . . ) to the phone in derived position 2.

This process continues until all phones have the correct numbered file for their position in the presentation.

The inventors recognised that the geo-position of a specific user was not important. What was required was the relative position of a participant within the graphic presentation.

The inventors also realised that the system did not require the audience to do anything to participate, other than, loading the app and holding up their cell phone. Each time one needs to ask a participant to perform some action like turning on GPS or linking to Wi-Fi adds an impedance to adoption of the system, and a point at which the process can be defined by a user as “too hard”. User participation is the main requirement to the success of the system 10. This realisation led to the concept of using the phone light itself to establish a cell phone's relative position within overall graphic presentation.

As shown in FIG. 2, as the camera 18 identifies each cell phone 12 received which component part of the graphic presentation, each cell phone 12 has an exclusive identifier. A matrix of the overall presentation is re-sorted to realign the cell phones 12 and send the correct positional file to each one.

The core requirement of these methods is the camera synchronisation to the graphic presentation. This feature and the small file size allows the system 10 to dynamically update the cell phones even during a show due to audience movement.

As these sorting methods are be presented as ‘part of the show’, there is no requirement to inform the audience that we are using this to define the positional data of their cell phone and as the positional data is only relative to the graphic presentation. There are no privacy concerns in relation to the identification of users.

Using this method, we only need to establish a cell phone position relative the graphic position that it is required to display during a show, and as such there is no requirement to formally identify a specific cell phone or its geo-location. This is a significant advantage over other methodologies that are in current use.

The system 10 can be programmed to display advertising, display messages, display images or display content relevant to the venue of the given area (such as colours of each team playing in a stadium).

The system 10 may display images synchronised with a musical clip.

The processor 22 should be capable of filtering all ambient light from the photographs to leave only the light from each of the cell phones 12.

The camera 18 should be capable of being externally controlled to photograph the given area. The given area is defined by marker lights. The given area defines the boundary of the presentation. Preferably, there should be four marker lights to define the boundary of the given area.

The camera 18 should be capable of autofocusing and have a method of high-speed communications to the processor 22. The resolution of the camera 18 should be adapted for the size of the given area. More than one camera may be required to cover the given area. As the camera may require a wide-angle lens it is also a requirement that the camera has such photographic correction techniques as to provide autocorrection for any resultant un-linearity.

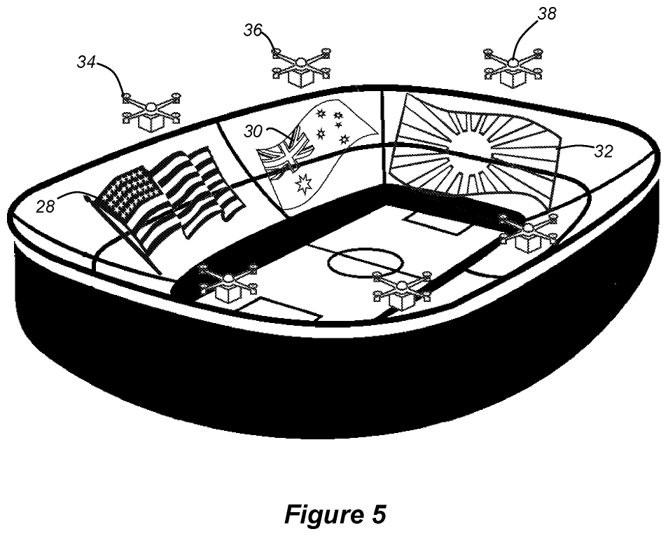

The system can use a Global Position Satellite (GPS) system to differentiate groups in the given area and provides presentations to each different group in the given area. As shown in FIG. 5, the system could be used to simultaneous display different flags 28, 30 and 32 on the phones of groups of people around different sections of a stadium. Those different sections could be imaged by cameras mounted on drones 34, 36 and 38 (respectively) hovering over the different sections of the stadium. Furthermore, the system could be used to differentiate groups all around the seating of a stadium so that a Mexican wave type effect could be used around all the different seating sections of the entire stadium. GPS is not sufficiently accurate to obtain an exact position of each phone with a sufficient degree of accuracy (which was a failing of the prior art). However, GPS is sufficiently accurate to differentiate large sections of a crowd (within a 40-meter accuracy).

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A computer implemented method for coordinating a presentation on a group of smartphones in a given area, the method comprising:
(a) operating a server for hosting a software application;
(b) operating a plurality of smartphones for running the software application which is adapted to connect to the server and display data on the smartphones;
(c) operating a camera for monitoring the lighting output of the smartphones in the given area; and
(d) operating a processor for controlling the camera and transmitting data to the software application running on each smartphone in the group to activate the lighting output of each smartphone,
wherein the unknown position of any smartphones in a presentation is determined by:
i) sending an initial data file to a first smartphone to activate a graphic on the first smartphone in the group;
ii) obtaining visual feedback from the camera as to the position of that first smartphone in the group;
iii) sending the correct data file based on the position of the first smartphone based on its position in the group for the display of the presentation across all the smartphones in the group;
iv) sending an initial data file to a second smartphone to activate a graphic on the second smartphone in the group;
v) obtaining visual feedback from the camera as to the position of the second smartphone in the group;
vi) sending the correct data file to the second smartphone in the group based on its position in the group for the display of the presentation across all the smartphones in the group;
vii) repeating the process for each smartphone in the group until all of the positions of all of the smartphones in the group have been sent the correct data file for the presentation across all the smart phones in the group.

2. (canceled)

3. The computer implemented method of claim 1, wherein the method includes a drone with the camera mounted thereto in order to position the drone in an optimal position to view the smartphones in the given area.

4. (canceled)
